(19) United States
(12) Patent Application Publication
(10) Pub. No.: US 2021/0106932 A1
(43) Pub. Date: Apr. 15, 2021

(54) OILS FREQUENCY CLEANER

(71) Applicant: Kamel Mahran Hussien Mam, Assiout (EG)

(72) Inventor: Kamel Mahran Hussien Mam, Assiout (EG)

(21) Appl. No.: 16/498,016

(22) PCT Filed: Apr. 3, 2017
(86) PCT No.: PCT/EG2017/000010

§ 371 Date: Sep. 26, 2019

(30) Foreign Application Priority Data
Mar. 27, 2017 (EG) 2017030532

(51) Int. Cl. B01D 29/86; B01D 29/64; B01D 21/00; B01D 21/18; B01D 35/28; B01D 29/90; B01D 21/24; C10G 31/09

(52) U.S. Cl. CPC B01D 29/86; B01D 29/6469; B01D 21/0018; B01D 21/18; B01D 35/28; B01D 29/90; C10G 2300/308; B01D 21/0012; C10G 31/09; B01D 2201/202; B01D 2201/204; C10G 2300/208; B01D 21/2405

(57) ABSTRACT

A brief description of the device

The machine works by frequency pressure, which is punctuated by a regular discharge of the pressure inside it and has a moving heart, a frequency movement which makes oil cleaning process not affect the basic oil properties and avoid the compression and adhesion of oil on the filters and clogged openings and oil enters the mechanism of the internal environment of the flattened and not the outer can save the deposits inside And disposal

Cleaning the surfaces of filters for the device it self because of its internal movement and there is space to collect the sediment, water disposal and cleaned manually or automatically

### TECHNICAL FIELD

the new system does not depend in its work on the centrifugation or different densities as in the filters or filters; nor the constant pressure and continuous on the surface f the separator filters as in the network or paper filters; and the consequences of the above mentioned problems; His work on the following:
Exhaust pressure works in the form of continuous waves; not continuous; interspersed with waves of vacuum pressure (discharge), which does not allow the particles of oil from the pressure and adhesion and accumulation on the separator surface of the filter.
The new device combines all the advantages of sedimentation, filtration, purification and propagation; avoiding the existing damage; because of its composition and working method; all in one unit, so that there is room for sedimentation and separation of water; pressure and mechanical movement of the internal heart; and the separation of impurities and residues—etc. because of its composition and the way the movement of oil within it and the movement of his heart to the interior.
   The iron device is entering the oil to the mechanism and then to the inner perimeter and out of the ocean; At all stages; Reverse filters network or paper;

The previous point; that all impurities, sediments, feathers and the like; be reserved within the filters; not on the outside perimeter of filters; and the consequent mixing of sediments with the oil system in case of clogging.

The internal movement of the inner heart with the presence of zippers around the inner perimeter of each filter exists; which takes the movement of the internal heart movement makes it difficult to accumulate and join and collect particles

The oil together; or on the surface of the separator and this in itself self-cleaning of the device is the opposite of the work of rotary filters.
The oil enters the mechanism in the form of wavelengths that interspersed with discharge; resulting in a movement of the internal heart; a reciprocating movement resulting from it; withdrawal of the adjacent oil particles and impurities; and the return to the center of the device; and the downward direction where there is a space to collect sediment and water.
The process of cleaning, purification, lubrication and sedimentation of oils within the device; without exposure to any mechanical or thermal stresses; affect the properties and quality of oils

### BACKGROUND ART

Man has defined several methods in the field of oil purification, especially used in internal combustion engines and others; the development of solutions for the disposal of water mixed with oils and carbon and soils and soil and cotton threads and discrete crusts of paints and residues of metals; and other undesirable materials; Are compounds of hydrogen and carbon and a proportion of paraffin wax and other elements; they are added to oils to acquire properties that are not in it or to improve desirable properties such as antioxidants, barrens, emulsifiers and foams 00000 etc. All these ingredients are mixed with Oils are subject to purification process

These include:
Sedimentation
Filtration
   Purification or propagation

Each method contributes to the process of oil cleaning by a certain percentage; it has the ability to separate

A certain type of impurities; not suitable for cleaning all impurities; but some of them are destructive to the chemical and physical properties of the oils themselves—We will review those methods

1—Precipitation

The oils are placed in tanks equipped with the deposition process so that the larger particles are oriented

Density of oils down to the bottom of the tannock; as well as by gravity and gravity, they accumulate and the water is bottomed and disposed of.

2—Nomination

There is more than one model for these filters, including a simple mesh filter; self-cleaning net filter; collacer filters; cartridge filters 000 etc., including coarse; soft on the diameter of the filter openings; including paper, which is used as a paper absorbent oils; oils can flow through it

3—Purifiers and Filters

Both normal and self-cleaning; and the idea of their work; there is a difference of densities between the materials to be purified or promoted; as well as through high-speed centrifugal speed up to 15000 rpm/minute 0

### The Problem or Deficiency in the Previous Art

Sedimentation Idea

Depending on gravity; heaviness; differing densities of mixed substances with oils; larger densities going down; and water and heavy sediments from a dedicated place; but particles that are less dense or larger than oil are attached to oil; The risk is not just oil, but the machines that use that oil, including very light particles, but if you enter the machine leads to problems in the oil openings; and the distances between the moving parts and fixed; and fall into the machine and the consequent damage.

### The Idea of Nomination

The idea of filtration depends on the pressure on the surface of the external filter by an external means which is the pumping pump of the oil; the pressure on the external environment flows into the inner ocean; and so whether copper mesh filters or paper are manufactured for this purpose, the oil flows through it, Because of the pressure of the pump; and the problems of these filters, first retina, it is subject to frequent obstruction at short intervals; and despite the tremendous development in the presence of types of automatic cleaner and programmed on it;

To be cleaned and cleaned manually; the reason is not in those filters themselves but in the theory of its work.

This is as follows:

First, these filters are subjected to oil pressure of about 4 bar, whether the pressure is greater or less; pressure is constantly exerted by pressure of the oil pump; this pressure is constant and continuous on the surface.

The result of this is the constant and continuous pressure of the accumulation and the binding and binding of the oil particles and impurities; all that exists in the oil on the boundary of those filters; when the clogging of filters in part occurs composition When the filters are removed for cleaning, a quantity of dissolved oil remains in the circuit; when the filter is installed after cleaning it, it is blocked in a short period.

Filters

Moreover, the surface of the separator is a paper oil plant so that the oil can flow through it; and the seizure of sediments between the folds of the outer surface; and problems of this type as follows:

The speed of the blockage and the accumulation of sediment between the paper folds; and does not fit with any cleaning operations, either manually or automatically; and is changed immediately after blockage; and the reason of blockage is the same reason that causes the blockage of the above network filters and this type is non-clean and re-use again

III. Filters and Purifications

Either filters or purification which used in the process of purification; depend in the way they work on the separation of impurities and water from oils as in the purifiers; or impurities as in the filters; by centrifugation of up to 15000 rolls/minute also on the difference densities between oils mixed materials The density of the materials to be refined; their density must be different; there should be a difference of densities between these materials; viscosity; temperature; Flow rate; A mixture of oil and problems and deficiencies in each of the former systems; any defect in one of the previous factors in terms of the values set for it; will negatively affect the purification process itself; on the one hand; on the other hand complex in design and maintenance and expensive; It has self-cleaning and automatic operation.

Defects and Problems

In addition to the above, we find that it is one of the most destructive things on oils and their properties, and for the following reasons:

Since the centrifuges are used in the analysis of compounds into their primary components; since the oils themselves are a compound containing more than one element; this is in addition to the compounds that are added to the oils In order to improve their properties; and secondly to acquire desirable properties; all those compounds mixed with oils are under the influence of centrifugal up to 15000 rpm/minute; thus breaking the bonds between these components and their separation; Part dissolves in the water and comes out with it; Sediments and impurities for different density from density The oil itself; and from the practical observations found that there are systems equipped with tanks deposition+filters purified rough+filters or filters+service tanks+rough filters; before the oil pump+soft filters after the pump+filters containing oil paper; It is blocked without exception; the end of the series is supposed to be less susceptible to clogging; the network filters are cleaned more than once; and the paper filters change more than once; during the period between changing the new oil to be damaged and changed again

### DISCLOSURE OF INVENTION

Including method of operation in cases of equipment, tools and equipment, or chemical preparation in chemical cases(

Agricultural, laboratory experiments, side effects, and tables and illustrations—if any—are attached to

Separate pages after the new items to be protected, with the drawings numbered and in a vertical position and not on them

Any explanatory data and know only parts of the drawing numbers are explained and explained within the detailed description(

### MODE OF OPERATION

The device is fed by a reciprocating pump; it operates by electricity or compressed air or takes its movement from the movement of the crankshaft 00 etc. It pulls the oil to be purified,

When withdrawing from the sedimentation tank No. (14) where the oil to be purified to service No. (15) Where the oil that has been purified we do

We open the following valves

(A)-(d)-(k)

We close the following valves

(G)-(j)-(c)-(b)

When you withdraw from the service tank, the service will be shipped to (15) to ten (15)

We open the following valves

(C)-(d)-(k)

We close the following valves

(A)-(b)-(g)-(j) When cleaning the machine we are paltry

We open the following valves

(B)-(g)-(j)

We close the following valves

(A)-(c)-(d)-(k)

This is done manually or automatically as the drawing

How the Device Works as Follows

After the processing of the circuit, as we have already operated Pump No. 13, the oil is withdrawn from the tank (14) and passes through the valve number (A) and (D) to the device as the drawing allows the internal heart of the device of the frequency movement; from top to bottom; And the reaction of the spring surrounding the filters that are present in it, which returns it to its first position at the moment of pressure drop of the reciprocating pump because its pressure has the value of bone and then the pressure collapses. The zipper returns the inner heart to its first position. And then passes the oil from the first filter of its internal environment is P The oil is released into the second filter, which is a net that does not have a filler of a coarse type; it is also inserted into the oil from the inner ocean; it traps the sediments and impurities that fit the diameter of the openings; The oil comes out of it to the last filter, which is a soft mesh type and has no filler; from it to the outside of the machine to drain the service or pull the oil pump on the machine to the paper filters

Three vertical filters; one horizontal; the three vertical filters clean the oil; or horizontal allow the sediment and water to pass through to the bottom of the device

Stability of the sediment accumulation area; or springs around the vertical filters; they help in the movement of the inner heart by frequency movement; it also cleans the surface of the vertical filters; pulls the sediment down into the sediment area; and the accumulation of sediments around the separation surfaces or even inside the filters; The pressure of the filter surfaces constantly; the entry of oil in the form of waves of pressure permeated by the discharge of pressure; this leads to the pull force to the center of the filter and this leads to the lack of accumulation and adhesion of oil on the surface of the filters as well as forcing the large and heavy particles to the direction down by pressure because of the entry of oil from the top And with pressure

Device Components

As shown in FIG. 6

FIG. 1 of FIG. 6 the body of the external device

FIG. 2 of FIG. 6 bonding strap

FIG. 3 of FIG. 6 mesh filter, non-linear paper filler

No. (4) of the FIG. 6 iron disk

FIG. 5 of FIG. 6 moving metal disc

FIG. 6 of the FIG. 6 iron disk

FIG. 7 of FIG. 6 Zippers

FIG. 8 of FIG. 6 mesh filter vertical filler

FIG. 9 of FIG. 6 zippers

FIG. 10 of FIG. 6 vertical coarse mesh filter

FIG. 11 of FIG. 6 zippers

FIG. 12 of FIG. 6 Soft vertical mesh filter

FIG. 13 of FIG. 6 oil pump

FIG. 14 of FIG. 6 drag or sediment tuck

This form is provided in original form

The student starts writing a new letter on the subject of the invention on this form, and uses white papers (A4) written on one face only to complete the subject (if needed

No. (15) of FIG. 6 The package or the service

No. (16) of FIG. 6 cleaning materials

FIG. 17 of FIG. 6 a differential pressure converter

FIG. 18 of FIG. 6 controller

FIG. 19 of FIG. 6 Sediment sedimentation

No. (20) of FIG. 6 Rubber ring

FIG. 21 of FIG. 6 the emergence of a fulcrum

Figure (A) of FIG. 6 Electric & Manual Valve

No. (B) of FIG. 6 Electric & Manual Valve

No. (C) of FIG. 6 Electric & Manual Valve

Figure (D) of FIG. 6 Electric & Manual Valve

No. (g) of FIG. 6 Electric & Manual Valve

No. (K) of FIG. 6 Electric & Manual Valve

No. (Z) of FIG. 6 Electric & Manual Valve

The following curves show the effect of continuous pressure on the surface of the separator; the pressure on the same surface; how to take advantage of this and from FIG. 1 note the adhesion of oil particles on the surface of the separator and when clogged holes begin to the particles in the compression and adhesion spread between the surface Of the filter until the pump is expelled and when cleaning the filter keeps part of the contaminated oil in the circuit, which speeds up the blockage again.

Given the FIG. 2

Note that oil enters the heart of the filter from its internal environment and not from its external environment. This is the opposite of the previous filters. This causes the oil contaminated material to be present inside the filter and does not bounce again when the filter is blocked.

The sediment and water into an assembly space at the bottom of the device by its frequency movement and the movement of its internal heart and the suction surrounding the vertical filters

In view of FIG. 3

We observe the relationship between the amount of flow and the angle of the column of the attachment as well as the expulsion. As for continuous pressure on the surface of the separator, we observe the constant flow and regularity in the package. This results in continuous and increasing pressure on the separator surface, which leads to the adhesion and accumulation of the oil particles.

In view of FIG. 4

We observe the relationship between the amount of flow and the angle of the attachment column as well as the expulsion in respect of The pressure on the surface indicates a rise in pressure and a repetitive drop in each cycle; the rise and fall of the pressure translates into an action on the rise and a reaction in the opposite direction; it is also frequent and leads to the decomposition of the adjacent layer and the accumulation of oils from above the dividing surface

In view of FIG. 5

We observe the relationship between the amount of flow and the angle of the attachment column as well as the expulsion in respect of

Pressure and a corresponding discharge on the dividing surface; we observe a rise in pressure and a downward trend in the opposite direction of the same rise; this does not give the oil a chance of adhering

And the accumulation on the surface of the separator; in the case of impurities or particles adjacent to the surface of the separator; the process of landing pressure in the opposite direction able to pull it into the middle of the filter; and the movement of the heart to the interior of the device makes these sediments heading to the space of the accumulation of sediments.

### EXPLANATION OF GRAPHICS

FIG. 1

Of the drawing represents the effect of continuous pressure, which is currently for the filtration of oil by the filters on the network or paper on the separation of the filter and how to block the holes and the accumulation of unwanted materials and mixing with the oil of the system as that

FIG. 1 of FIG. 1—Pull the oil pump

FIG. 2 of FIG. 1—Oil pump

FIG. 3 of FIG. 1—Contiguous particles and impurities due to blockage of the filter

FIG. 4 of FIG. 1—Ordinary oil particles but stuck due to blockage of the filter

No. (5) of FIG. 1—filter

FIG. 6 of FIG. 1—Oil exit slot

FIG. 7 of FIG. 1—the particles accumulated on the surface of the interval

FIG. 2

Of the drawing represents the effect of the alternating pressure of the discharge as well as the entry of oil from the inner perimeter of the filter and not from the outside perimeter where the impurities are collected inside the filter and not mixed with the oil system again because it is drawn down to the private assembly space,

FIG. 1 of FIG. 2—pull the frequency pump

FIG. 2 of FIG. 2—oil pump

FIG. 3 of FIG. 2—Filter

FIG. 4 of FIG. 2—oil output

FIG. 5 of FIG. 2—The accumulated and adjacent particles inside the filter

FIG. 3

From the graph, the curve represents the flow quantity, the angle of the attachment column, and the pressure in the constant pressure on the outside of the filter

FIG. 1 of FIG. 3—the amount of flow

FIG. 2 of FIG. 3—Corner of the attachment column

FIG. 3 of FIG. 3—Pump expulsion

FIG. 4

Of the graph represents the curve between the flow quantity and the angle of the attachment column and the discharge of the AC pressure

FIG. 1 of FIG. 4—the amount of flow

FIG. 2 of FIG. 4—Corner of the attachment column

FIG. 3 of FIG. 4—The expulsion of the pump

We observe the arrival of the pressure to the value of the bone and the landing; the regular process of rise and fall in the pressure to act and reaction to the oil, which does not give him the opportunity to join or accumulate on the dividing surface

FIG. 5

Of the graph represents the curve between the amount of flow and the angle of the elbow column and the expulsion of the pump is hesitant and the heart of the mobile device frequency movement

FIG. 1 of FIG. 5—Flow quantity

FIG. 2 of FIG. 5—Corner of the attachment column

FIG. 3 of FIG. 5—Pump expulsion

We see a rise in pressure and descent; at the moment of descent, the clouds are drawn into the interior by the movement of the inner heart of the apparatus; which leads to the creation of a pull force of the oil particles that attach to the dividing surface to the heart of the filter and its disassembly and non-disassembled parts are oriented down into the sediment

FIG. 6

FIG. 1 of FIG. 6

Represents the body of the device

FIG. 2 of FIG. 6

The horizontal filter assembly with the rest of the device components

FIG. 3 of FIG. 6

This form is provided in original form

The student starts writing a new letter on the subject of the invention on this form, and uses white papers (A4) written on one face only to complete the subject (if needed

Filter Filling

FIG. 4 of FIG. 6

A steel disc to fix the inner heart set and to separate the purification chamber and the sediment space

FIG. 5 of FIG. 6

The iron disc is the previous disk into the purifier and install the internal filters set

FIG. 6 of FIG. 6

A moving metal disc is a frequency movement that is a number (4) and a number (5) of the separation unit and the accumulation of sediments inside and moving them down

FIG. 7 of FIG. 6

Shock absorber resulting from the movement of the inner heart moving moving movement and balance of the moving part

FIG. 8 of FIG. 6

Filter Filling—Rough

FIG. 9 of FIG. 6

Zippers help in the internal movement of the moving heart and to clean the surfaces

FIG. 10 of FIG. 6

Network filter—rough

FIG. 11 of FIG. 6

Zippers help in the internal movement of the moving heart and to clean the surfaces

FIG. 12 of FIG. 6

Network filter—soft

FIG. 13 of FIG. 6

Oil pump

FIG. 14 of FIG. 6

Remove the oil to be cleaned

FIG. 15 of FIG. 6

Tank Service

FIG. 16 of FIG. 6

Cleaning the appliance

FIG. 17 of FIG. 6

A pressure transducer to measure the pressure before and after the device and when it exceeds half a kilogram/cm 2 gives a signal to the control unit to open and close the electric valves that clean the device for 60 seconds and then return the circuit to normal operation

FIG. 18 of FIG. 6

The control unit that operates the device automatically and includes alarm, surveillance and protection

FIG. 19 of FIG. 6

The accumulation of sediments

FIG. 20 of FIG. 6

Rubber ring

FIG. 21 of FIG. 6

Iron railing to fix the inner parts of the device)

(A)-(b)-(c)-(d)-(g)-(k)-(j)

Automatic control valves for automatic operation with manual valves in parallel with the electric valves to be operated manually in the event of an electrical circuit failure.

Method of Exploitation

It exploited in the field of cleaning oils and purification of non-material desirable; which represents damage to the oil system or equipment using those oils; especially those equipment operating in the maritime field; internal combustion; and all the equipment working in difficult conditions and long hours of work; It is used in all systems, whether they are working and intended to purify its oil during work; or work is the case and the renewal of its oil during work; also used if the equipment parked and do not work and can operate as a separate unit for stomach one; or as a central most of the stomach, provided that work in the same oil; And can be a revelation Home of the same machine by connecting pumps with constant pressure to take the critical device to the machine; can be more than one unit cleaning plug straight or parallel to the control and in the quality of cleaning; and the amount of oil to be cleaned.

### BRIEF DESCRIPTION OF DRAWING

FIG. 1

Of the drawing represents the effect of continuous pressure, which is currently for the filtration of oils by the filters on the network or paper on the separator of the filter and how to block the holes and the accumulation of unwanted materials and mixing with the oil system since the

FIG. 1 of FIG. 1 Pull the oil pump

FIG. 2 of FIG. 1 oil pump

FIG. 3 of FIG. 1 The following particles and reagents due to blockage of the filter

FIG. 4 of FIG. 1 is normal oil particles but is stuck due to blockage of the filter

FIG. 5 of FIG. 1 Filter

FIG. 6 of FIG. 1 oil exit slot

FIG. 7 of FIG. 1 The particles accumulated on the surface of the interval

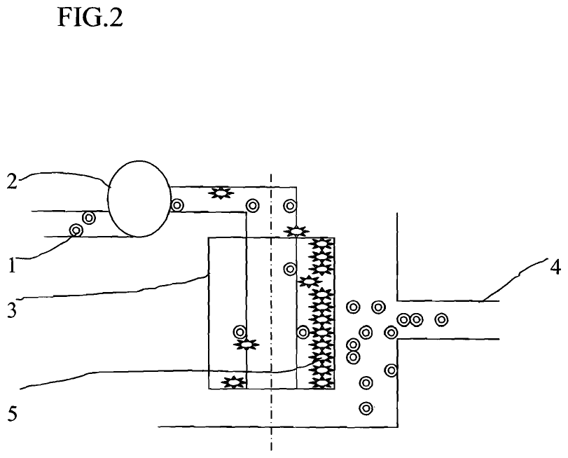

FIG. 2

Of the drawing represents the effect of the alternating pressure of the discharge as well as the entry of oil from the inner perimeter of the filter and not from the outside perimeter where the impurities are collected inside the filter; and not mixed with the oil of the system again because it is drawn constantly to the assembly space,

FIG. 2 of FIG. 2 oil pump

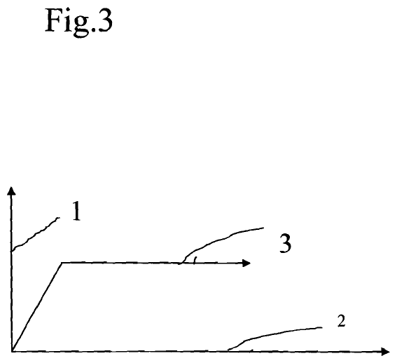

FIG. 3 of FIG. 2 Filter

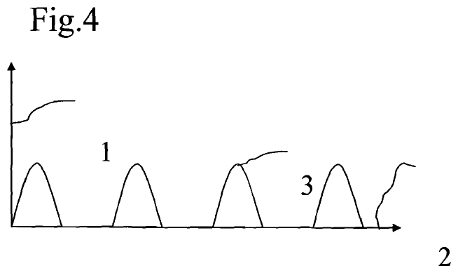

FIG. 4 of FIG. 2 oil output

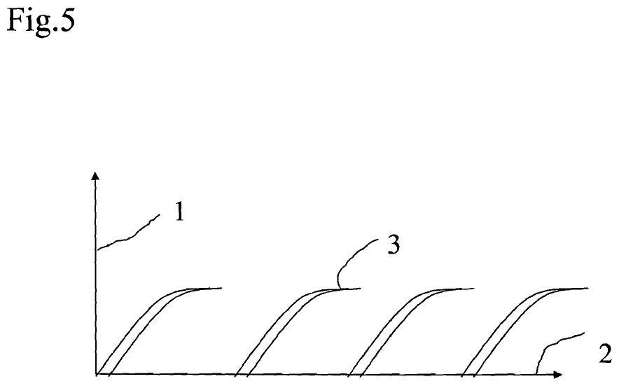

FIG. 5 of FIG. 2 The accumulated and adjacent particles inside the filter

FIG. 3

From the graph, the curve represents the flow quantity, the angle of the attachment column, and the pressure in the constant pressure on the outside of the filter

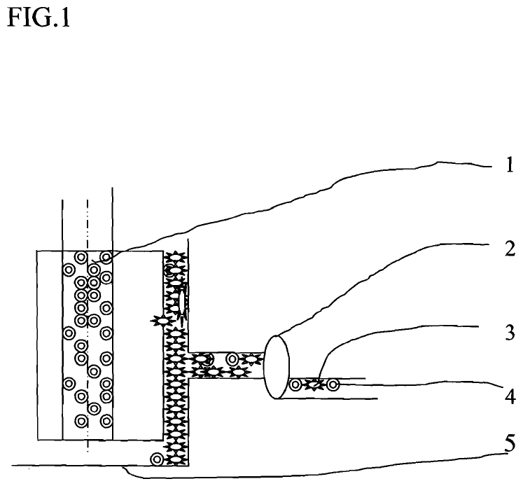

FIG. 1 of FIG. 3 flow quantity

FIG. 2 of FIG. 3 corner of the attachment column

FIG. 3 of FIG. 3 Pump expulsion

FIG. 4

Of the graph represents the curve between the flow quantity and the angle of the attachment column and the discharge of the AC pressure

FIG. 1 of FIG. 4 flow quantity

FIG. 2 of FIG. 4 Corner of the attachment column

FIG. 3 of FIG. 4 Pump expulsion

We observe the arrival of pressure to the value of greatness and then landing; and regularly the process of rise and fall in the pressure; lead to an act and reaction on the oil, which does not give him the opportunity to join or accumulate on the dividing surface

FIG. 5

Of the graph represents the curve between the amount of flow and the angle of the elbow column and the expulsion of the pump is hesitant and the heart of the mobile device frequency movement

FIG. 1 of FIG. 5 flow quantity

FIG. 2 of FIG. 5 Corner of the attachment column

FIG. 3 of FIG. 5 Pump expulsion

We see a rise in pressure and descent; at the moment of descent the clouds are drawn inward by the internal movement of the heart of the device; which leads to the finding of the pulling force of the oil particles that are attached to the dividing surface to the heart of the filter and dismantle; the non-disassembled parts are moving down to the sediment

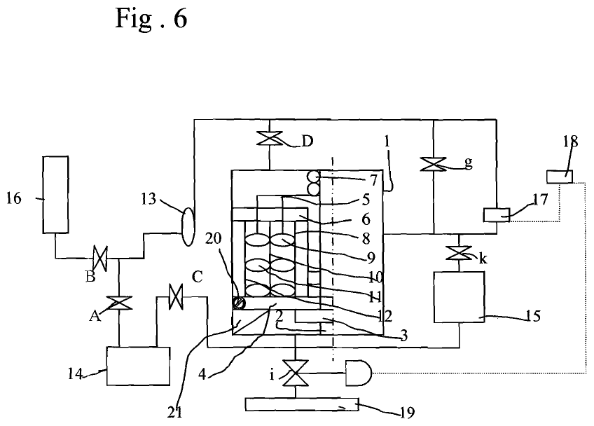

FIG. 6

FIG. 1 of FIG. 6

Represents the body of the device

FIG. 2 of FIG. 6

The horizontal filter assembly with the rest of the device components FIG. 3 of FIG. 6

Filter Filling

FIG. 4 of FIG. 6

A steel disc to fix the inner heart set and to separate the purification chamber and the sediment space

FIG. 5 of FIG. 6

The iron disc is the previous disk into the purifier and install the internal filters set

FIG. 6 of FIG. 6

A moving metal disc is a frequency movement that is a number (4) and a number (5) of the separation unit and the accumulation of sediments inside and moving them down

FIG. 7 of FIG. 6

Shock absorber resulting from the movement of the inner heart moving mobile frequency movement and balance of the moving part

FIG. 8 of FIG. 6

Filter Filling—Rough

FIG. 9 of FIG. 6

Zippers help in the internal movement of the moving heart and to clean the surfaces

FIG. 10 of FIG. 6

Network filter—rough

FIG. 11 of FIG. 6

Zippers help in the internal movement of the moving heart and to clean the surfaces

FIG. 12 of FIG. 6

Network filter—soft

FIG. 13 of FIG. 6

Oil pump

FIG. 14 of FIG. 6

Remove the oil to be cleaned

FIG. 15 of FIG. 6

Tank Service

FIG. 16 of FIG. 6

Cleaning the appliance

FIG. 17 of FIG. 6

A pressure transducer to measure the pressure before and after the device and when it exceeds half a kilogram/cm 2 gives a signal to the control unit to open and close the electric valves that clean the device for 60 seconds and then return the circuit to normal operation FIG. 18 of FIG. 6

The control unit that operates the device automatically and includes alarm, surveillance and protection

FIG. 19 of FIG. 6

The accumulation of sediments

FIG. 20 of FIG. 6

Rubber ring

FIG. 21 of FIG. 6

Iron railing to fix the inner parts of the device

(A)-(b)-(c)-(d)-(g)-(k)-(j)

Automatic valves to control the operations in which the device is automatic with the presence of hand valves in parallel with the electric valves to be operated manually in case of failure in the circuit

1. An oils frequency cleaner comprising: a reciprocating pump; it provides non-continuous pressure; and a moving internal heart with a frequency movement; it has more than one stage for oil cleaning; and three spikes; one absorbs shock from the internal movement and stabilizes the moving parts; The oil enters the machine from the internal environment of the filters in it; it does not use paper filters in its internal stages; it has a space for collecting the rock And can be cleaned manually or automatically; and can be connected more than one unit in a row or parallel to obtain higher quality or more quantities of oil that is cleaned; works whether the machine in the case of work or parking condition without affecting the original system; It is the basic system for filtering oil for any machine

2. The oil cleaner frequency according to claim 1, wherein the device operates by frequency pressure.

3. The Oil-frequency cleaner according to claim 1, wherein the internal heart is moving a frequency movement, so the sediment is scraped from the internal filter surfaces from top to bottom

4. The Oil-frequency cleaner according to claim 1, wherein the oil enters its interior flux from the inner perimeter and not from the outside. Therefore, the sediments accumulate inside the filters and not in the space surrounding the filters is form is provided in original form.
